(19) United States
(12) Patent Application Publication
(10) Pub. No.: US 2007/0138981 A1
(43) Pub. Date: Jun. 21, 2007

(54) Apparatus and method for controlling an energy flow between a solar energy source and an electric motor

(76) Inventors: Franz Roecker, Ampher Khao Suan Kwang (TH); Prasit Sakwilawan, Khao Suan Kwang (TH)

Correspondence Address: HENNEMAN & ASSOCIATES, PLC, 714 W. MICHIGAN AVENUE, THREE RIVERS, MI, 49093, US

(21) Appl. No.: 11/604,643

(22) Filed: Nov. 27, 2006

(30) Foreign Application Priority Data
Nov. 29, 2005 (DE) 10 2005 058 140.4

(51) Int. Cl. H02P 1/54

(52) U.S. Cl. 318/109

(57) ABSTRACT

The invention relates to an apparatus for controlling an energy flow between a solar energy source and an electric motor. An electrical circuit having an energy flow control device is arranged between the input side and the output side. In accordance with one aspect of the invention, the circuit has an energy store, which is connected to the energy flow control device. This energy flow control device is designed to pass energy stored in the energy store to the motor in the event of a predetermined first voltage threshold of the energy store being exceeded. The invention also relates to a solar energy source having a corresponding apparatus and to a method for controlling an energy flow.

### FOREIGN PRIORITY

This application claims the right of foreign priority to Application No. 10 2005 058 140.4 filed in Germany on Nov. 29, 2005 by the same inventors, which is incorporated herein by reference in its entirety.

### BACKGROUND OF THE INVENTION

The present invention relates to an apparatus for controlling an energy flow between a solar energy source and an electric motor, the apparatus having an input side for an input voltage and an output side for an output voltage, and an electrical circuit having an energy flow control device being arranged between the input side and the output side.

The invention also relates to a method for controlling an energy flow between a solar energy source and an electric motor, the energy flow being controlled by means of an electrical circuit.

Finally, the invention also relates to a solar energy source, in particular a solar module for the home and garden sector.

In order to operate an electric motor, the energy required for this purpose can be obtained by means of a solar energy source. A solar energy source is in this case generally understood to be an energy source which is based on the photovoltaic principle, in which radiation energy (in this case solar energy) is converted into electrical energy. It is possible, for example, to operate a water pump for the home and garden sector by means of a solar module. In this case, essentially two ways are used for operating water pumps.

The first possibility is using a brushless motor having an electronic commutator. With such water pumps, the rotor is the only part which is subject to wear, which results in a long life. In addition, the rotor can be replaced at any time. However, it has been shown that inducing the required magnetic field requires a considerable amount of power from the solar energy source. Owing to their high cost, these water pumps have only found a low level of acceptance among consumers.

The second possibility consists in the use of a motor with brushes. Owing to the considerably lower energy consumption, this type of water pump has been very popular among consumers. The disadvantage of such a water pump, however, is the fact that the brushes and the corresponding contact faces on the commutator are subjected to additional wear. Over the course of time, this results in such a pump requiring higher startup currents and often also having an increasing energy requirement.

The life expectancy of such a water pump, which is already less than in the case of a brushless motor, in interaction with a solar energy source is reduced further still for the reasons given below.

It is known with solar modules that they have a particular current/voltage characteristic. While a considerable voltage, for example 80% of the rated voltage, is generated even in the case of low light conditions, the current produced by the solar energy source increases only slowly as the amount of incident light increases.

If a water pump is connected to a solar energy source, this results, in the event of a low amount of incident light, in a current flowing through the motor which is insufficient for causing the motor to rotate. Since the current flows via the brushes of the motor, sparking results at the transition between the brushes and the corresponding contact faces.

The resultant additional wear results, inter alia, in the startup current required for starting up the motor increasing. This results in the motor starting up ever later as the amount of incident light is increasing (for example at the beginning of the day), which in turn results in the period of time for which sparking takes place becoming ever longer. This may finally result in the water pump no longer starting up at all although the solar module produces a current which would be sufficient for driving an already running motor.

Furthermore, it is necessary to take care that the rotation speed of a water pump essentially depends on the voltage which is supplied to the water pump.

The cost of a solar module is essentially dependent on the power which it can produce. In order to arrive at a correspondingly favourable solar module for a given water pump, an attempt is made to obtain a voltage which is as high as possible, in which case it is necessary to accept a reduction in the maximum current level. This dependency intensifies the problem that, from a certain point in time on, the solar energy source can no longer produce sufficient current for allowing the water pump to start up.

The application WO 2005/011874 A2, filed by the present Applicant, has proposed an improvement to the extent that a switching element is arranged between the solar energy source and the water pump, which switching element connects the current path to the electric motor of the water pump only when the voltage produced by the solar energy source is greater than or equal to the minimum operating voltage of the electric motor.

In this way, it has in practice been possible to reduce the probability of failure of an overall structure comprising a solar energy source and a water pump. However, it is still desirable here to reduce the electrical losses brought about by the additional switching element.

### BRIEF SUMMARY OF THE INVENTION

Against this background, it is an object of the present invention is to specify an improved and cost-effective apparatus and a corresponding method for controlling an energy flow between a solar energy source and an electric motor. In this case, an electric motor should be understood in particular to be those electric motors having brushes which are used in water pumps for the home and garden sector.

In accordance with one aspect of the invention there is provided an apparatus of the type mentioned at the outset, wherein the circuit has an energy store, which is connected to the energy flow control device, and the energy flow control device is designed to pass energy stored in the energy store to the electric motor in the event of a predetermined first voltage threshold of the energy store being exceeded.

In accordance with another aspect of the invention there is also provided a solar energy source of the type mentioned at the outset, in particular a solar module, which has an apparatus of the above-described type.

In accordance with yet another aspect of the invention there is provided a method of the type mentioned at the outset, wherein an energy store is charged and, in the event of a predetermined voltage level of the energy store being exceeded, the stored energy is passed to the electric motor.

In order to explain the particular feature of the invention, consideration will now be given to the situation in which the solar energy source produces insufficient power for allowing the electric motor to start up. The term insufficient power should be understood to the extent that the current available to the motor and/or the available voltage are insufficient either for startup or for operation of the motor.

When the motor is not running, a large portion of the produced current now flows from the solar energy source not to the electric motor but to the energy store. In this case, the energy store, in particular a capacitor, is charged to an increasing extent over the course of time.

While the energy store is charged, the voltage of the energy store (figuratively the “fill level” of the energy store) is monitored by the energy flow control device. If the voltage of the energy store exceeds the predetermined first voltage threshold, the energy flow control device passes the stored energy to the motor. The voltage threshold is in this case selected such that the motor starts up when it is supplied with the energy.

Owing to the motor starting to rotate, a cleaning effect is introduced on the brushes and the contact faces of the commutator. In this manner, the energy provided by the solar energy source—even if it is insufficient for continuous operation of the motor—can be used for cleaning the brushes and the contact faces. It is thus possible to avoid a situation in which the required startup current (possibly even the required continuous current) increases and the life expectancy of the motor in interaction with the solar energy source is shortened. Here, note will be made of the fact that the solar energy source preferably has amorphous solar cells since a particularly favourable overall system thus results.

In a preferred embodiment of the invention, the energy source has a positive output, and the motor has a positive input, the positive output being coupled to the positive input by means of the circuit, and the positive output and the positive input also being connected to one another by a low-resistance circuit element.

The low-resistance circuit element, which is preferably a line, passes some of the current provided by the solar energy source directly to the motor. With regard to the level of the current flowing to the motor, it is necessary to distinguish between two important states:

If the amount of incident light on the solar energy source is so low that the motor cannot begin to rotate, a large portion of the produced current flows into the circuit, in particular into the energy store, while only a small portion of the current flows directly to the motor.

On the other hand, during normal operation, when the produced current is sufficient for rotating the motor, a large portion of the current flows via the low-resistance circuit element. As a result, only the smaller portion of the current, i.e. the portion which flows through the circuit, is subject to losses. For normal operation, this means that the power produced by the solar energy source arrives at the motor with fewer losses.

In particular, there is not the power loss via the circuit element present in prior art devices. This in turn means that a smaller solar module can be used or that a solar module of the same size has higher reserves.

In a further preferred embodiment of the invention, the first voltage threshold is greater than a maximum output voltage of the energy source.

In this way it is possible to ensure particularly well that the motor actually also starts up when it is supplied with the energy from the energy store. In addition, this ensures that the motor also starts up when it requires a higher startup current owing to general ageing effects.

If one considers the case in which the solar energy source produces a current which is sufficient for rotating a running motor further but is insufficient for allowing the motor to start up, the energy surge with the increased voltage can be understood as a starting aid. In this case, the term maximum output voltage should be understood as meaning the highest voltage which can be provided by the solar energy source under best-possible conditions.

In a further preferred embodiment of the invention, the apparatus has a step-up voltage converter, which is connected upstream of the energy store.

It is thus possible for the abovementioned higher voltage to be produced in a simple manner. Alternatively, possibly even additionally, a charge pump can be used for increasing the voltage.

In addition, it is preferred that the energy flow control device is designed to prevent energy from being passed from the energy store to the motor if a voltage level of the energy store falls below a second voltage threshold

As has already been mentioned above, in the event of a low amount of incident light, the produced energy is stored in the energy store and released at the point in time at which the energy is sufficient for causing the motor to rotate. When the amount of incident light is low, however, this results in the energy store running empty more rapidly than it can be recharged by the solar energy source. This could result in a situation in which, by means of the energy from the energy store, a current is brought about by the motor which is no longer sufficient for rotating the motor further.

In order to avoid sparking on the brushes of the motor in this state, it is therefore proposed to suppress the energy flow when if the voltage level of the energy store falls below the second voltage threshold. Depending on the implementation selected of the energy flow control device, the second voltage threshold may be selected to be essentially as great as the first voltage threshold or else made equivalent thereto.

In a further preferred embodiment, in order to control the energy flow, a thyristor is arranged between the energy store and the motor.

Such a semiconductor switch can be implemented in a cost-effective manner and is robust. In particular, simple coupling between the voltage in the energy store and the release of energy from the energy store is therefore made possible.

In a further preferred embodiment of the invention, the circuit is arranged in parallel with the energy source.

From the point of view of the motor, the circuit therefore acts as a backup for the solar energy source. It is particularly advantageous here to combine this preferred embodiment with the step-up voltage converter described above. It has been shown in practical experiments that, in addition to its function in the case of low light conditions, the circuit also has a further effect:

During normal operation, the circuit allows for a higher voltage to be applied to the electric motor than is produced by the solar energy source. As a result, it is possible to use solar modules having a lower rated voltage or the same solar module has higher reserves. An explanation for this effect is assumed by the Applicant to lie in the fact that the circuit moves the solar energy source into a better working point, possibly in the direction of the best power point (maximum power point, MPP).

It goes without saying that the abovementioned features and the features yet to be explained below can be used not only in the respectively given combination but also in other combinations or on their own without leaving the scope of the present invention.

Exemplary embodiments of the invention are illustrated in the drawing and will be explained in more detail in the description below. In the drawing:

### BRIEF DESCRIPTION OF THE SEVERAL VIEWS OF THE DRAWING

FIG. 1 shows a preferred embodiment of an apparatus according to the invention;

FIG. 2 shows a section of the temporal profile of a method according to the invention; and

FIG. 3 shows a solar energy source according to the invention.

### DETAILED DESCRIPTION OF THE INVENTION

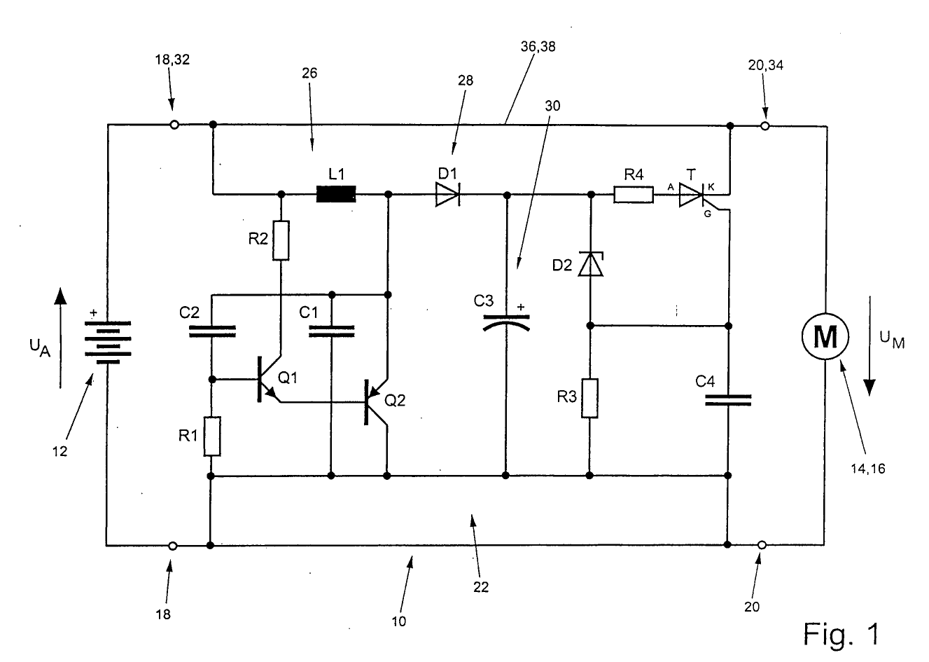

FIG. 1 shows an apparatus 10 for controlling an energy flow, which apparatus is arranged between a solar-operated energy source 12 and an electric motor 14, in this case in a water pump 16. Here, the apparatus 10 has an input side 18 for an input voltage U_{A} and an output side 20 for an output voltage U_{M}.

An electrical circuit 22 having an energy flow control device 24 is arranged between the input side 18 and the output side 20. The energy flow control device 24 has a thyristor T having an anode A, a cathode K and a control terminal G, has a zener diode D2 and a capacitance C4 and resistors R3, R4, the capacitance C4 reducing or suppressing interfering frequency feedback from the rotating motor 14 to the control terminal G.

In addition, the circuit 22 has a step-up voltage converter 26 (inductance L1, capacitances C1, C2, resistors R1, R2 and transistors Q1, Q2), a rectifier 28, in this case a diode D1, and an energy store 30, in this case a capacitance C3. When viewing the circuit 22 from the input side 18 in the direction of the output side 20, the mentioned elements are arranged in series with one another as follows: step-up voltage converter 26, rectifier 28, energy store 30 and energy flow control device 24.

The solar energy source 12 has a positive output 32, and the motor 14 has a positive input 34. The positive output 32 and the positive input 34 are coupled to one another via the circuit 22. In addition, the positive output 32 and the positive input 34 are connected to one another by a low-resistance circuit element 36, in this case a line 38.

The operation of the apparatus 10 will now be explained in more detail. In this case consideration is first paid to the case in which the power provided by the solar energy source 12 is neither sufficient for allowing the water pump 16 to start up nor sufficient for rotating the water pump 16 further if it were already to be in motion. In this case, the current flows from the solar energy source 12 primarily into the circuit 22, while only a small portion of the current flows via the motor 14.

In the step-up voltage converter 26, the input voltage U_{A} is stepped up. The diode D1 then ensures that the AC voltage produced in the process only reaches the energy store 30 with one half-cycle. The capacitance C3 in this case has a maximum voltage of between 10 V and 20 V, in particular between 14 V and 18 V, preferably of approximately 16 V.

Owing to the energy supplied by the solar energy source 12 and owing to the thyristor T, which is off, the voltage level of the capacitance C3 increases until a first voltage threshold, in this case the breakthrough voltage of the zener diode D2, is exceeded. When the zener diode D2 breaks through, the control terminal G of the thyristor T becomes positive, and the thyristor T is turned on, i.e. it becomes a low-resistance component. The first voltage threshold was in this case selected to be between 8 V and 18 V, in particular between 12 V and 16 V, preferably to be approximately 14 V.

Once the thyristor T has been turned on, the energy flows from the capacitance C3 to the motor 14. The voltage provided by the capacitance C3 is in this case higher, in particular substantially higher than the rated voltage required for operating the motor 14. This ensures that the motor 14 actually starts up and sparking is avoided.

Since it has been assumed that the motor 14 consumes more power than the solar energy source 12 can produce at that time, this means that the voltage level of the capacitance C3 decreases ever further until, finally, the holding current at the control terminal G becomes too low and the thyristor T is turned off again, i.e. becomes a high-resistance component. The motor 14 ceases to rotate, and the charging process of the capacitance C3 begins again.

Consideration will now be given to the case in which the solar energy source 12 produces a power which would be sufficient for further rotation of the motor 14 but does not make startup of the motor 14 possible. In this case, charging of the capacitance C3 and the release of energy to the motor 14 again takes place in the above-described manner. When the motor 14 finally rotates, the majority of the current produced by the solar energy source 12 flows via the line 38 directly to the motor 14. As a result, the motor 14 can be operated in the continuous operation mode with only low energy losses.

In the experimental setup, it has also been shown that the circuit 22 can increase the voltage applied to the motor 14 in comparison with the voltage provided merely by the solar energy source 12.

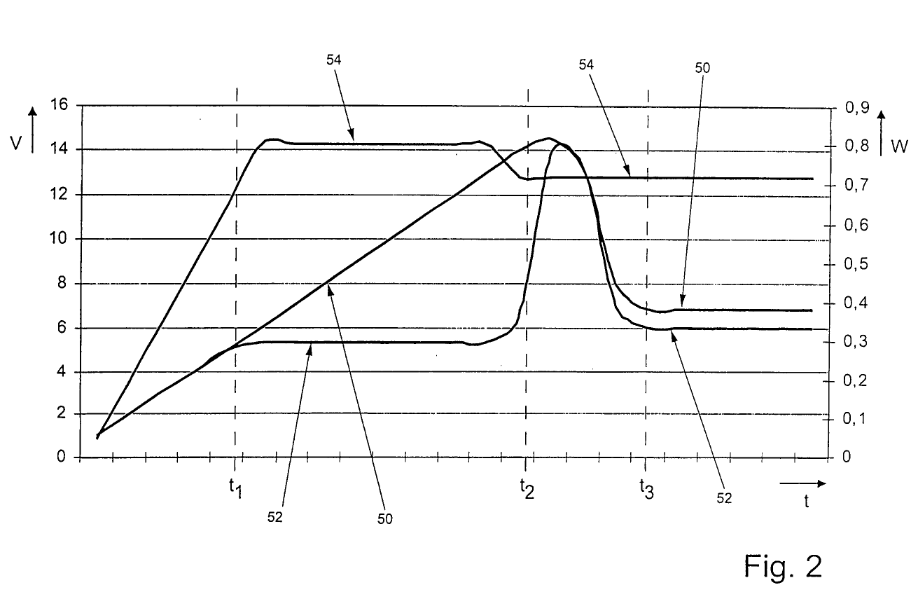

An exemplary profile for starting the motor 14 in the lastmentioned case is represented in the graph in FIG. 2. In this case, the x-axis represents a time axis for the time t. The left-hand y-axis shows a voltage scale between 0 V and 16 V, and the right-hand y-axis shows a power scale between 0 W and 0.9 W. The curve 50 shows the profile of a voltage level of the capacitance C3, the curve 52 shows the voltage applied to the motor 14, and the curve 54 shows an exemplary profile for the power produced by the solar energy source 12.

At the beginning of the temporal illustration it is assumed that the power output of the solar energy source increases from approximately 0.05 W to approximately 0.8 W. It can be seen from the curve 52 that the voltage available to the motor first rises, but then remains essentially constant at approximately 5.2 V from a time t₁ on.

In this example it has been assumed that the power available after the time t₁ is insufficient for allowing the motor 14 to start up, for example because a higher voltage would be required for this purpose.

Another profile is shown for the voltage profile (illustrated in the curve 50) at the capacitance C3. In this case, the voltage also continues to increase after the time t₁ until, finally, the thyristor T is turned on in the vicinity of the time t₂ in the energy flow control device 24, and the energy from the capacitance C3 is passed to the motor 14. As can clearly be seen from the profile of curve 52, this results in an increase in the voltage at the motor 14 for a short period of time. In the example shown, this “starting aid” is sufficient for allowing the motor 14 to start up.

As the profile continues, the abovementioned effect of the circuit 22 can finally be seen. While, before the time t₂, it was the primary task of the circuit 22 to charge the capacitance C3 and therefore to be able to make available an additional energy surge, a voltage increased by approximately 0.8 V is now available to the motor 14 during normal operation. Although the increased voltage results in a reduction in the current available, it has been shown in practice that this loss tends to be unproblematic.

The voltage increase shown firstly provides additional reserves during operation, for example if the light conditions worsen. Secondly, the apparatus 10 also makes it possible to use a solar energy source 12 having smaller dimensions, with the result that, overall, a less expensive overall system can be provided.

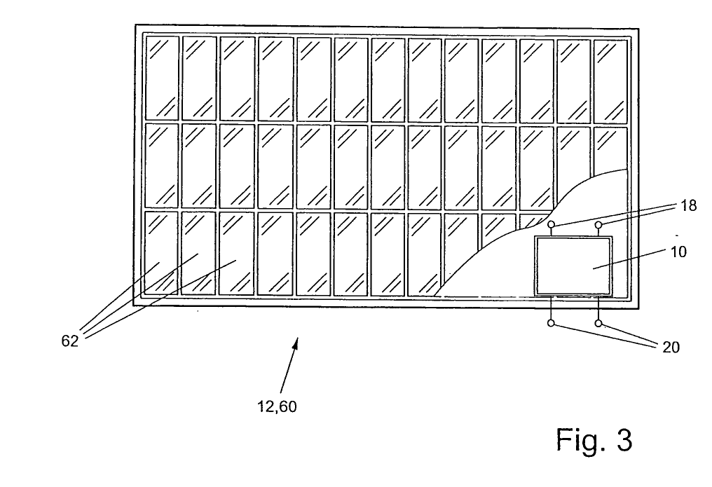

Finally, FIG. 3 shows a solar energy source 12, in this case a solar module 60, having solar cells 62 and the above-described apparatus 10. Since the apparatus 10 can be realized in a simple and compact manner, a solution which is overall inexpensive and efficient can be provided.

We claim:

1. An apparatus for controlling an energy flow between a solar energy source and an electric motor, the apparatus having an input side for an input voltage and an output side for an output voltage, and an electrical circuit having an energy flow control device being arranged between the input side and the output side, wherein the circuit has an energy store, which is connected to the energy flow control device, and the energy flow control device is designed to pass energy stored in the energy store to the electric motor in the event of a predetermined first voltage threshold of the energy store being exceeded.

2. The apparatus according to claim 1, wherein the solar energy source has a positive output, and the motor has a positive input, the positive output being coupled to the positive input by means of the circuit, and the positive output and the positive input also being connected to one another by a low-resistance circuit element.

3. The apparatus according to claim 1, wherein the solar energy source has a maximum output voltage, and the first voltage threshold is greater than the maximum output voltage.

4. The apparatus according to claim 1, further comprising a step-up voltage converter, which is connected upstream of the energy store.

5. The apparatus according to claim 1, wherein the energy flow control device is adapted to prevent energy from being passed from the energy store to the motor if a voltage level of the energy store falls below a second voltage threshold.

6. The apparatus according to claim 1, wherein, in order to control the energy flow, a thyristor is arranged between the energy store and the motor.

7. The apparatus according to claim 1, wherein the circuit is arranged in parallel with the solar energy source.

8. A solar energy source for the home and garden sector, comprising an apparatus for controlling an energy flow between the solar energy source and an electric motor, the apparatus having an input side for an input voltage and an output side for an output voltage, and an electrical circuit having an energy flow control device being arranged between the input side and the output side, wherein the circuit has an energy store, which is connected to the energy flow control device, and the energy flow control device is designed to pass energy stored in the energy store to the electric motor in the event of a predetermined first voltage threshold of the energy store being exceeded.

9. The solar energy source according to claim 8, wherein the solar energy source has a positive output, and the motor has a positive input, the positive output being coupled to the positive input by means of the circuit, and the positive output and the positive input also being connected to one another by a low-resistance circuit element.

10. The solar energy source according to claim 8, wherein the solar energy source has a maximum output voltage, and the first voltage threshold is greater than the maximum output voltage.

11. The solar energy source according to claim 8, further comprising a step-up voltage converter, which is connected upstream of the energy store.

12. The solar energy source according to claim 8, wherein the energy flow control device is adapted to prevent energy from being passed from the energy store to the motor if a voltage level of the energy store falls below a second voltage threshold.

13. The solar energy source according to claim 8, wherein, in order to control the energy flow, a thyristor is arranged between the energy store and the motor.

14. The solar energy source according to claim 8, wherein the circuit is arranged in parallel with the solar energy source.

15. A method for controlling an energy flow between a solar energy source and an electric motor, the energy flow being controlled by means of an electrical circuit, wherein an energy store is charged and, in the event of a predetermined voltage level of the energy store being exceeded, an energy stored in the energy store is passed to the motor.
